(19) United States
(12) Patent Application Publication
(10) Pub. No.: US 2020/0160374 A1
(43) Pub. Date: May 21, 2020

(54) SYSTEM AND METHOD FOR DEVELOPING AND PRESENTING CUSTOMIZED OFFERS TO POTENTIAL CUSTOMERS

(71) Applicants: Jim Cooksey, Dallas, TX (US); Travis Furr, Dallas, TX (US)

(72) Inventors: Jim Cooksey, Dallas, TX (US); Travis Furr, Dallas, TX (US)

(21) Appl. No.: 16/195,280

(22) Filed: Nov. 19, 2018

(51) Int. Cl. G06Q 30/02; G06N 99/00

(52) U.S. Cl. CPC G06Q 30/0244; G06N 99/005; G06Q 30/0269

(57) ABSTRACT

A computer-implemented method for developing and presenting customized offers to a potential customer. The method comprises acquiring a plurality of attributes associated with each of a plurality of potential customers, determining, based upon the plurality of attributes associated with each of the plurality of potential customers, potential customers to receive customized offers, determining, via an offer-determination protocol, a customized offer for a first potential customer based upon at least some of the plurality of attributes associated with the first potential customer, presenting the customized offer to the first potential customer, monitoring a response of the first potential customer to receiving the customized offer, and updating the offer-determination protocol based upon the response of the potential customer. Also, a system for developing and presenting customized offers to a potential customer.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The disclosure generally relates to the development and presentation of customized offers to potential customers.

### BACKGROUND

Conventionally, providers of products and services have advertised their products and services to the general public to increase consumer awareness and, hopefully, improve business. Mass-marketing techniques, such as television, radio, and mailings, generally direct a single advertisement to hundreds, thousands, or even hundreds of thousands of potential consumers. More recently, advertisers have employed electronic messages, such as e-mail and short-message-service (e.g., “SMS” or “text” messages) to reach potential consumers.

While advertisers have attempted to direct their advertisements to potential consumers most-likely to be receptive to those advertisements, these targeted-advertising techniques nonetheless rely upon generalized demographics to place advertisements. For example, advertisers might utilize advertisements directed toward children during Saturday-morning cartoons or advertisements directed toward men during football games. Although advertisers may target certain groups of potential customers, such advertisements nonetheless utilize a single advertisement to present a single offer to many potential customers.

### SUMMARY

In some embodiments disclosed herein is a computer-implemented method comprising acquiring a plurality of attributes associated with each of a plurality of potential customers, determining, based upon the plurality of attributes associated with each of the plurality of potential customers, potential customers to receive customized offers, determining, via an offer-determination protocol, a customized offer for a first potential customer based upon at least some of the plurality of attributes associated with the first potential customer, presenting the customized offer to the first potential customer, monitoring a response of the first potential customer to receiving the customized offer, and updating the offer-determination protocol based upon the response of the potential customer. In some embodiments, the plurality of customer attributes associated with a potential customer includes a name of the potential customer, an income of the potential customer, a credit score of the potential customer, an occupation of the potential customer, a hobby or interest of the potential customer, an address of the potential customer, an email of the potential customer, a mobile phone number of the potential customer, a purchasing history of the potential customer, a payment history of the potential customer, a social network identity of the potential customer, a marital status of the potential customer, whether the potential customer has children, whether the potential customer has pets, a criminal history of the potential customer, a number of complaints lodged by the potential customer, or combinations thereof. In some embodiments, determining, via the offer-determination protocol, the customized offer for the first potential customer is further based upon at least some of a plurality of attributes associated with a good or service to which the customized offer is related. In some embodiments, presenting the customized offer comprises sending an electronic message. The electronic message may comprise an email or a text message. The electronic message may include a link to a landing page that sets forth at least some of a plurality of offer attributes. The offer attributes may include a product or service to which the offer is related, a price of the product or service, a financing term associated with the customized offer, a discount applicable to the customized offer, an incentive conditioned on acceptance of the customized offer, or combinations thereof. The landing page may include an “accept” button, and monitoring the response of the first potential customer to receiving the customized offer may comprise determining whether the accept button has been clicked. In some embodiments, updating the offer-determination protocol based upon the response of the potential customer comprises a machine-learning methodology. The machine-learning methodology may comprise rule-based learning, association rule learning, artificial neural networks, deep learning, support vector machine learning, cluster analysis, representation learning, learning classification systems, or combinations thereof. In some embodiments, the customized offer is for an apartment lease. In some embodiments, the customized offer is for an automobile lease.

Additionally, in some embodiments disclosed herein is a system for developing and presenting customized offers to a potential customer, the system comprising a customer information database and an offer-determination computer in signal communication with the customer information database and a user device. The offer-determination computer may be configured to acquire from the customer information database a plurality of attributes associated with each of a plurality of potential customers, determine, based upon the plurality of attributes associated with each of the plurality of potential customers, potential customers to receive customized offers, determine, via an offer-determination protocol, a customized offer for a first potential customer based upon at least some of the plurality of attributes associated with the first potential customer, present, via the user device, the customized offer to the first potential customer, monitor a response of the first potential customer to receiving the customized offer, and update the offer-determination protocol based upon the response of the potential customer. In some embodiments, the plurality of customer attributes associated with a potential customer includes a name of the potential customer, an income of the potential customer, a credit score of the potential customer, an occupation of the potential customer, a hobby or interest of the potential customer, an address of the potential customer, an email of the potential customer, a mobile phone number of the potential customer, a purchasing history of the potential customer, a payment history of the potential customer, a social network identity of the potential customer, a marital status of the potential customer, whether the potential customer has children, whether the potential customer has pets, a criminal history of the potential customer, a number of complaints lodged by the potential customer, or combinations thereof. In some embodiments, the offer-determination computer is further configured to determine, via the offer-determination protocol, the customized offer for the first potential customer based upon at least some of a plurality of attributes associated with the a good or service to which the customized offer is related. In some embodiments, the offer-determination computer is configured to present the customized offer by sending an electronic message. In some embodiments, the electronic message comprises an email or a text message. The electronic message may include a link to a landing page that sets forth at least some of a plurality of offer attributes. The offer attributes may include a product or service to which the offer is related, a price of the product or service, a financing term associated with the customized offer, a discount applicable to the customized offer; an incentive conditioned on acceptance of the customized offer, or combinations thereof. The landing page may include an “accept” button, and the offer-determination computer may be configured to monitor the response of the first potential customer to receiving the customized offer comprises by determining whether the accept button has been clicked. In some embodiments, the offer-determination computer is configured to update the offer-determination protocol based upon the response of the potential customer by a machine-learning methodology. The machine-learning methodology may comprise rule-based learning, association rule learning, artificial neural networks, deep learning, support vector machine learning, cluster analysis, representation learning, learning classification systems, or combinations thereof. In some embodiments, the customized offer is for an apartment lease. In some embodiments, the customized offer is for an automobile lease.

### BRIEF DESCRIPTION OF THE DRAWINGS

FIG. 1 is a flowchart depicting an embodiment of a method 100 for developing and presenting customized offers to a potential customer.

FIG. 2 is a schematic illustration of an embodiment of a system for developing and presenting customized offers to a potential customer.

FIG. 3 is an embodiment of the offer-determination computer.

### DETAILED DESCRIPTION

Disclosed herein are methods and systems for developing and presenting customized offers to a potential customer. In various embodiments, the methods and systems disclosed herein may be employed to offer products and/or services of various types. For example, the methods and systems disclosed herein may be employed to develop and present a customized offer related to a real estate purchase, lease, or rental (such as an apartment-lease, a home-lease, an apartment rental, or a home rental), real-estate services, an auto purchase or lease, a mobile-device purchase or lease, investment products, investment services, banking products, banking services, consumer products, retail services, or combinations thereof.

In various embodiments, a “potential customer” may be an individual, a business organization, or any other entity. The potential customer may be a returning customer (for example, to whom the advertiser has previously administered services) or a new customer (for example, to whom the advertiser has previously administered services).

In various embodiments, a “customized offer” may be an offer to render a particular product or service to a particular potential customer. The customized offer may include a plurality of offer attributes that are particular to the “potential customer” to whom the customized offer is directed. For example, the customized offer may include particular offer attributes such as the price of the products or services being offered, financing terms associated with the products or services being offered, discounts applicable to the products or services being offered, incentives linked to acceptance of the customized offer (such as a gift-card, a consumer-good, an additional rebate, a loyalty reward, or the like) and combinations thereof.

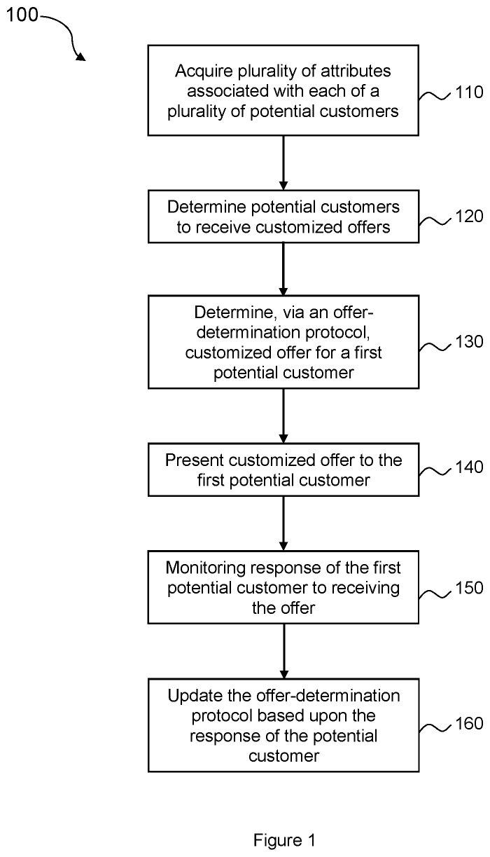

Referring to FIG. 1, an embodiment of a method 100 for developing and presenting customized offers to a potential customer is shown. In the embodiment of FIG. 1, the method 100 generally comprises the steps of acquiring a plurality of attributes associated with each of a plurality of potential customers, at block 110; determining, based upon the plurality of attributes associated with each of the plurality of potential customers, potential customers to receive customized offers, at block 120; determining, via an offer-determination protocol, a customized offer for a first potential customer based upon at least some of the plurality of attributes associated with the first potential customer, at block 130; presenting the customized offer to the first potential customer, at block 140; monitoring a response of the first potential customer to receiving the customized offer, at block 150; and updating the offer-determination protocol based upon the response of the potential customer, at block 160.

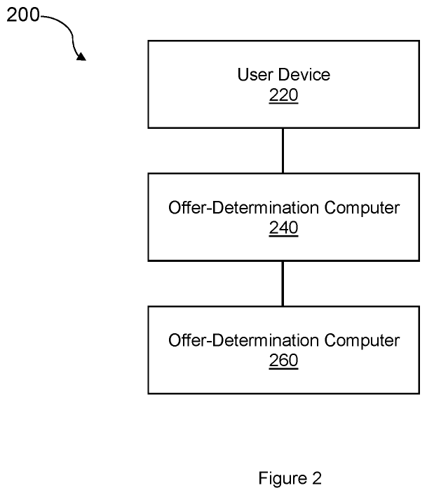

In some embodiments, the method for developing and presenting customized offers to a potential customer (for example, method 100), may be implemented via a system 200 for developing and presenting customized offers to a potential customer. For example, referring to FIG. 2 is a schematic illustration of an embodiment of a system for developing and presenting customized offers to a potential customer. In the embodiment of FIG. 2, the system 200 generally includes a user device 220, a customer information database 240, and an offer-determination computer 260.

In various embodiments, the components of the system 200 may be operably connected via one or more networks (for example, a broadband network, an optical network, a Wi-Fi network, a Bluetooth network, a near-field communication (NFC) network, a cellular network, a satellite network, a cloud network, a card processing network, a banking network, a local area network, the World Wide Web for Internet, a non-cellular mobile phone network, a land-line network, a Public Switched Telephone Network (PSTN), a dedicated communication line, some other networks for transferring electronic information, or combinations thereof). Particularly, in some embodiments, the offer-determination computer 260 may be operably connected to, for example, in signal communication with, ach of the customer information database 240 and the user device 220.

In various embodiments, the user device 220 may comprise a personal computer, a tablet, a mobile phone such as a smartphone, a cloud computing system, a server, or combinations thereof. The user device 220 may be configured by the user or consumer to send, receive, and/or access one or more electronic messages having a suitable format. For example, in various embodiments, the electronic message may be formatted as electronic mail (i.e., an email such as email utilizing simple mail transfer protocol (SMTP) or another suitable protocol); a short-message-service (SMS) (i.e., a “text” message); an instant message (IM); a personal message or private message (PM), for example, which may be provided via a social-networking platform (e.g., Twitter, Facebook, Instagram) or via a private messaging platform (e.g., WhatsApp, Kik Messenger, Snapchat); or combinations thereof.

Additionally or alternatively, in some embodiments the user device 220 may also be configured to provide Internet access, for example, comprising suitable hardware and software (e.g., an Internet browser) for connection to and navigation of various networks via which Internet access may be obtained. The user device 220 may also comprise a suitable user interface, for example, a graphical user interface which may be implemented and/or manipulated via a touch screen, a keyboard, a mouse, a trackball, voice-command, or combinations thereof.

In various embodiments, the customer information database 240 may comprise a collection of data for each of a plurality of potential customers. The customer information database 240 may comprise any suitable database configuration. In some embodiments, the customer information database 240 may be maintained by the offeror (that is, the entity presenting the customized offer). For example, in various embodiments the customer information database 240 may comprise a database comprising prior customers, a database comprising prospective customers, or combinations thereof. Additionally or alternatively, the customer information database 240 may be maintained by a third-party who allows access by the offeror (e.g., licenses the customer information database 240). For example, in some embodiments a third party may maintain databases including prospective customers that the third party believes may be interested.

In various embodiments, the attributes associated with the potential customer and present in the customer information database 240 may include, for example, the name of the potential customer, the income of the potential customer, the credit score of the potential customer, the occupation of the potential customer, the hobbies or interests of the potential customer, the contact information (such as address, email, home phone number, and mobile phone number) of the potential customer, the relevant purchasing history of the potential customer, the payment history of the potential customer (such as whether the potential customer has missed payments or made late payments and, if so, in what number or frequency), social network identity (such as a link to a Facebook or other social-networking profile), marital status of the potential customer, whether the potential customer has children (and, if so, names, ages, etc.), whether the potential customer has pets (and, if so, the number, type, etc.), criminal history, complaints lodged by the potential customer, or the like.

In various embodiments, offer-determination computer 260 may be generally configured to perform one or more steps of the method 100 generally disclosed with respect to FIG. 1, for example, one or more of the steps of acquiring a plurality of attributes associated with each of a plurality of potential customers, determining, based upon the plurality of attributes associated with each of the plurality of potential customers, potential customers to receive customized offers, determining, via an offer-determination protocol, a customized offer for a first potential customer based upon at least some of the plurality of attributes associated with the first potential customer, presenting the customized offer to the potential customer, monitoring a response of the potential customer to receiving the customized offer, and updating the offer-determination protocol based upon the response of the potential customer. Additionally, in some embodiments the offer-determination computer 260 may be further configured to perform other functions, for example, as will be disclosed herein.

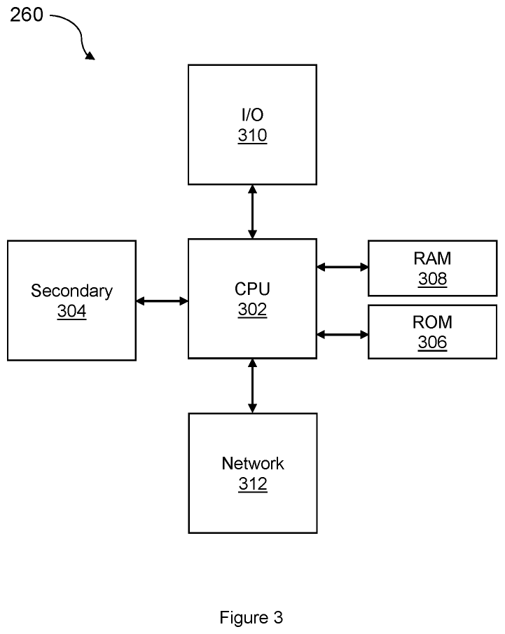

The offer-determination computer 260 comprises and is implemented via a particular machine generally comprising sufficient processing power, memory resources, and network throughput capability to handle the necessary workload placed upon it. FIG. 3 illustrates an embodiment of the offer-determination computer 260 suitably configured to implement all, or a portion of, one or more embodiments disclosed herein. The offer-determination computer 260 includes a processor 302 (which may be referred to as a central processor unit or CPU) that is in communication with memory devices including secondary storage 304, read only memory (ROM) 306, random access memory (RAM) 308, input/output (I/O) devices 310, and network connectivity devices 312. The processor 302 may be implemented as one or more CPU chips.

It is understood that by programming and/or loading executable instructions onto the offer-determination computer 260, at least one of the CPU 302, the RAM 308, and the ROM 306 are changed, transforming the offer-determination computer 260 in part into a particular machine (and/or a special-purpose computer) having the particular, novel functionalities disclosed herein and thereby enabled to perform the novel and nonobvious methods, tasks, processes, and steps disclosed herein; thus, the offer-determination computer 260 does not constitute and cannot be implemented via a general purpose machine. It is fundamental to the electrical engineering and software engineering arts that a particular functionality that can be implemented by loading executable software into a computer (or a component thereof) and, likewise, that a particular functionality that can be implemented via hardware utilizing well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine (and/or special-purpose computer).

In some embodiments, the secondary storage 304 may be comprised of one or more disk drives or tape drives, for example, which may be used for non-volatile storage of data and as an over-flow data storage device if RAM 308 is not large enough to hold all working data. Secondary storage 304 may be used to store programs which are loaded into RAM 308 when such programs are selected for execution. The ROM 306 is used to store instructions and perhaps data which are read during program execution. ROM 306 is a non-volatile memory device which typically has a small memory capacity relative to the larger memory capacity of secondary storage 304. The RAM 308 is used to store volatile data and perhaps to store instructions. Access to both ROM 306 and RAM 308 is typically faster than to secondary storage 304. The secondary storage 304, the RAM 308, and/or the ROM 306 may be referred to in some contexts as computer readable storage media and/or non-transitory computer readable media.

In some embodiments, the I/O devices 310 may include printers, video monitors, liquid crystal displays (LCDs), touch screen displays, keyboards, keypads, switches, dials, mice, track balls, voice recognizers, card readers, paper tape readers, or other well-known input devices.

In some embodiments, the network connectivity devices 312 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 312 may enable the processor 302 to communicate with the Internet or one or more intranets. With such a network connection, it is contemplated that the processor 302 might receive information from the network or might output information to the network in the course of performing the above-described method steps. Such information, which is often represented as a sequence of instructions to be executed using processor 302, may be received from and outputted to the network, for example, in the form of a computer data signal embodied in a carrier wave.

Such information, which may include data or instructions to be executed via the processor 302 may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 302 executes instructions, codes, computer programs, scripts which it accesses from a hard disk, a floppy disk, an optical disk (these various disk-based systems may all be considered secondary storage 304), ROM 306, RAM 308, or the network connectivity devices 312. While only one processor 302 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 304, for example, hard drives, floppy disks, optical disks, and/or other device, the ROM 306, and/or the RAM 308 may be referred to in some contexts as non-transitory instructions and/or non-transitory information.

In some embodiments, the offer-determination computer 260 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the offer-determination computer 260 to provide the functionality of a number of servers that is not directly bound to the number of computers in the offer-determination computer 260. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In some embodiments, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer-usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the offer-determination computer 260, at least portions of the contents of the computer program product to the secondary storage 304, to the ROM 306, to the RAM 308, and/or to other non-volatile memory and volatile memory of the offer-determination computer 260. The processor 302 may process the executable instructions and/or data structures in part by directly accessing the computer program product, for example by reading from a CD-ROM disk inserted into a disk drive peripheral of the offer-determination computer 260. Alternatively, the processor 302 may process the executable instructions and/or data structures by remotely accessing the computer program product, for example by downloading the executable instructions and/or data structures from a remote server through the network connectivity devices 312. The computer program product may comprise instructions that promote the loading and/or copying of data, data structures, files, and/or executable instructions to the secondary storage 304, to the ROM 306, to the RAM 308, and/or to other non-volatile memory and volatile memory of the offer-determination computer 260.

In some contexts, the secondary storage 304, the ROM 306, and the RAM 308 may be referred to as a non-transitory computer readable medium or a computer readable storage media. A dynamic RAM embodiment of the RAM 308, likewise, may be referred to as a non-transitory computer readable medium in that while the dynamic RAM receives electrical power and is operated in accordance with its design, for example during a period of time during which the offer-determination computer 260 is turned on and operational, the dynamic RAM stores information that is written to it. Similarly, the processor 302 may comprise an internal RAM, an internal ROM, a cache memory, and/or other internal non-transitory storage blocks, sections, or components that may be referred to in some contexts as non-transitory computer readable media or computer readable storage media.

In various embodiments, the offer-determination computer 260 may be configured to perform all, substantially all, or part of a method for developing and presenting customized offers to a potential customer (for example, the method disclosed with respect to FIG. 1). In some embodiments, the offer-determination computer 260 may be configured to perform one or more of the steps (e.g., the steps disclosed with respect to FIG. 1) in real-time or substantially in real-time. As used herein, processing in “real-time” refers broadly completion of one or more processing tasks, from receipt of in input to generation of an output based upon that input, without any appreciable delay, for example, as opposed to “batch” processing.

In some embodiments, in the performance of a method for developing and presenting customized offers to a potential customer (for example, in the performance of the method 100 of FIG. 1), the offer-determination computer 260 may access the customer information database 240 (alternatively, multiple customer information databases 240) to acquire a plurality of attributes associated with each of plurality of potential customers (e.g., block 110 of FIG. 1). The particular attributes sought and acquired may vary according to the offer-determination protocol implemented by the offer-determination computer 260. For example, in some embodiments the offer-determination computer, implementing the offer-determination protocol, may filter the available attributes to acquire only those attributes of potential customers that are most-pertinent or most-effective in the context of developing the customized offer.

In some embodiments, the offer-determination computer 260 may utilize the plurality of attributes associated with each of the plurality of potential customers to determine which of the plurality of potential customers should receive a customized offer (e.g., block 120 of FIG. 1). The offer-determination computer 260 may implement the offer-determination protocol to determine those potential customers who it is most-desirable to present with an offer, for example, those potential customers who are most-likely to accept the offer, who are most-likely to maximize income by the offeror, who are most-likely to minimize expenses by the offeror, who are most-likely to maximize profitability by the offeror, who are most-likely to select a particular product, who are most likely to select a particular service, some other criteria of the offeror, or combinations thereof.

In some embodiments, the offer-determination computer 260 may utilize the plurality of attributes associated with a particular potential customer of the plurality of potential customers (i.e., a first potential customer) to determine the customized offer for the first potential customer offer (e.g., block 130 of FIG. 1). Additionally, in some embodiments the offer-determination computer 260 may utilize a plurality of attributes associated with a good or service to be offered to the first potential customer to determine the customized offer for the first potential customer. In various embodiments, the attributes associated with a potentially-offered good or service can include, for example, the cost of the good or service, any special incentives applicable to the good or service, transaction costs associated with the good or service, the availability of the good or service, the demand for the good or service, the desirability of the good or service with respect to a particular potential customer, the applicability or usefulness of the good or service with respect to a particular potential customer, or the like. In various embodiments, the offer may be determined in accordance with a desired criteria, for example, such that the potential customer is most-likely to accept the offer; such that, if the offer is accepted, the offeror's profits will be maximized; such that, if accepted, the offeror's expenses will be minimized; or some other criteria of the offeror; or combinations thereof.

In some embodiments, in the determination of the customized offer, the offer-determination computer 260 may filter the available attributes associated with the first potential customer those attributes, consistent with the offer-determination protocol, necessary to determine the customized offer so as to achieve a desired criterion. In some embodiments, in the determination of the customized offer, the offer-determination computer 260 may additionally or alternatively filter the attributes associated with the good or service to be offered, consistent with the offer-determination protocol, necessary to determine the customized offer so as to achieve a desired criterion. In some embodiments, in the determination of the customized offer, the offer-determination computer 260 may additionally or alternatively determine one or more additional attributes, for example, which may be derived or inferred from the various available attributes. For example, such additional attributes may include mathematical relationships which may be calculated from the available attributes (e.g., an income-to-payment ratio) or inferred from the available attributes (e.g., a customer preference index, based upon prior purchasing history).

In various embodiments, the offer-determination computer 260 may be determine one or more of the offer attributes for the customized offer to be offered to the potential customer, implementing the offer-determination protocol. For example, in various embodiments the offer-determination computer 260 may determine the particular product or service that will be offered; the price of the products or services that will be offered; financing terms (e.g., interest rate and/or term) associated with the products or services that will be offered; any discounts applicable to the products or services that will be offered; any incentive conditioned on acceptance of the customized offer that will be offered; and combinations thereof. Taken together, the particularized offer attributes, as determined via the offer-determination protocol, constitute the customized offer.

Additionally, in some embodiments, the offer-determination computer 260 may also determine one or more other attributes associated with presentation of the customized offer to the first potential customer. For example, the offer-determination computer 260 may determine, based upon the attributes of the first potential customer or the attributes associated with the good or service to be offered, the best method of communicating with the first potential customer, the best time of day and/or day of the week to communicate the customized offer, the appearance (e.g., aesthetics of the presentation) of the offer itself, or the like. Additionally or alternatively, the offer-determination computer 260 may be configured to communication the customized offer based upon the location or accessibility of the first potential customer. For example, the offer-determination computer 260 may be configured to communicate the offer when the first potential user accesses (e.g., connects to) a particular network (e.g., a particular Wi-Fi network). In some embodiments, the determination of one or more attributes with respect to the customized offer may occur in real-time or substantially in real-time.

In some embodiments, upon determining the customized offer to be presented, the offer-determination computer 260 may present the customized offer to the to the first potential customer via a suitable electronic message (e.g., block 140 of FIG. 1). For example, the offer-determination computer 260 may, in accordance with any determinations (e.g., method for best reaching the first potential customer and/or aesthetics or preferences of the first potential customer), format the offer an email, a text message, an instant message, a personal message or private message (PM) via a social-networking platform or via a private messaging platform. The offer-determination computer 260 may also, again in accordance with any determinations (e.g., time of day and/or day of week for best reaching the first potential customer) cause the message to be sent to the first potential customer, for example, via the electronic-messaging protocol and at the time determined by the offer-determination computer 260.

In some embodiments the, the offer attributes may be set forth within the electronic message sent to the first potential customer; additionally or alternatively, in some embodiments, the electronic message sent to the first potential customer may direct the first potential customer, for example, via a link, to a webpage (e.g., a landing page) setting forth the specific offer attributes. For example, the first potential customer may receive the electronic message (e.g., an email, test message, IM, or PM) via the first potential customer's user device 220 (e.g., a smartphone or personal computer). In some embodiments where the electronic message sets forth the offer attributes, the electronic message may also allow the first potential customer to “accept” the customized offer, for example, by clicking a link or an “accept” button or by replying to the electronic message. In some embodiments where the electronic message directs the first potential customer to a landing page, the landing page may similarly include a link or an “accept” button allowing the first potential customer to accept the customized offer.

In some embodiments, the offer-determination computer 260 may monitor a response of the first potential customer to receipt of the customized offer (e.g., block 150 of FIG. 1). For example, in embodiments where the customized offer may be accepted electronically, the offer-determination computer 260 may monitor the first potential customer's response (e.g., whether or not the first potential customer has accepted the customized offer) by determining whether or not the first potential customer has clicked the acceptance link, has visited the acceptance landing page, or has responded to the electronic message conveying the customized offer.

In some embodiments, the first potential customer may accept the customized offer personally, for example, by visiting or calling a place-of-business of the offeror and presenting the customized offer. In such embodiments, the offeror may input the first potential customer's acceptance of the customized in a format accessible by the offer-determination computer 260. For example, the offeror may update a record associated with the first potential customer, alternatively, with the product or services being offered, to indicate that the first potential customer has accepted the customized offer. In embodiments where the first potential customer may accept the customized offer personally, the offer-determination computer 260 may monitor the first potential customer's response by monitoring (e.g., checking, at intervals) any records associated with the first potential customer or the offered product or service for an indication that the first potential customer has accepted the customized offer.

In some embodiments, the customized offer presented to the first potential customer may have an associated period of validity (e.g., a time prior to which the offer expires). In some embodiments, if the first potential customer fails to accept the customized offer, the offer-determination computer 260 may send one or more follow-up electronic messages during the period of validity associated with the customized offer. In some embodiments, the offer-determination computer 260 may alter one or more of the ways in which the electronic message is delivered, the way in which the customized offer is presented, or the day and/or time at which the electronic message is delivered. For example, if the original electronic message setting forth the customized offer was sent via email in the evening on a weekday, any follow-up message setting forth the customized offer may be sent via text message, in the morning, on a weekend.

In some embodiment, upon a determination that the first potential customer has accepted the customized offer, the offer-determination computer 260 may, responsive to the acceptance, take one or more additional steps to complete the transaction associated with the offered good or service. For example, the offer-determination computer 260 may generate and send to the first potential customer one or more additional forms, documents, or the like for presentation to the first potential customer. For example, in various embodiments, and depending upon the context, upon acceptance of the offer, the offer-determination computer may generate a lease agreement, a purchase agreement, a financing agreement, a financing application, an automated funds transfer agreement (e.g., an automated clearing house (ACH) form), instructions for completion of the transaction to purchase the good or service (e.g., pick-up instructions or a shipping confirmation), the like, or combinations thereof.

In some embodiments, upon termination of the period of validity (e.g., expiration of the customized offer), the offer-determination computer 260 may determine that the first potential customer has not accepted (e.g., has rejected) the customized offer. In some embodiments, responsive to a determination that the first potential customer has not accepted the customized offer, the offer-determination computer 260 may revise one or more of the offer attributes, relative to the customized offer that the first potential customer did not accept. Additionally or alternatively, in some embodiments, response to a determination that the first potential customer has not accepted the customized offer, the offer-determination computer 260 may determine, via the offer-determination protocol, a customized offer for another potential customer (e.g., a second potential customer) based upon at least some of the plurality of attributes associated with the second potential customer (e.g., block 130 of FIG. 1) and present the customized offer to the second potential customer (e.g., block 140 of FIG. 1). The determination by the offer-determination computer 260 as to whether to revise the customized offer or to present an offer to another potential customer may be based upon the desired goal or criteria (e.g., such that the potential customer is most-likely to accept the offer; such that, if the offer is accepted, the offeror's profits will be maximized; such that, if accepted, the offeror's expenses will be minimized; or some other criteria of the offeror; or combinations thereof). For example, in some embodiments the offer-determination computer 260 may modify one or more of the particular good or service being offered, the price of the products or services being offered, financing terms (e.g., interest rate and/or term) associated with the products or services being offered, any discounts applicable to the products or services being offered; any incentive conditioned on acceptance of the customized offer being offered, and combinations thereof, relative to the customized offer initially offered and not accepted.

In some embodiments, the method may further comprise reporting one or more results, based upon the response of the first potential customer (e.g., learned from monitoring the response of the first potential customer to receipt of the customized offer). For example, in various embodiments the offer-determination computer 260 may develop one or more reports based upon the status of a plurality of pending customized offers, upon a particular good or service being offered, upon a particular customized offer, or the like. In some embodiments, the development and making available any particular report may occur in real-time or substantially in real-time with respect to the results of a response being determined. As such, a user can have available up-to-the moment statistics with respect to pending customized offers.

In some embodiments, the offer-determination computer 260 may update the offer-determination protocol based upon the response of the potential customer (e.g., block 160 of FIG. 1). For example, in some embodiments the offer-determination protocol computer 260 may update the offer-determination protocol such that, when implemented, the offer-determination protocol will determine customized offers that more nearly achieve the desired criteria when determining future customized offers. In some embodiments, the offer-determination computer 260 may utilize one or more techniques associated with artificial intelligence in order to improve the offer-determination protocol, for example, machine learning. As used herein, “machine learning” generally refers to any computer-implemented statistical technique by which a computer or computer system is able to progressively improve the performance (e.g., the results associated with) a particular task or goal. Examples of suitable machine-learning methodologies, as may be suitably employed to update the offer-determination protocol (for example, such that when implemented, the offer-determination protocol will determine customized offers that more nearly achieve the desired criteria) may include, but are not limited to decision tree learning; rule-based learning; association rule learning; artificial neural networks and deep learning; support vector machine learning; cluster analysis; representation learning; learning classification systems; and the like.

In various embodiments, by utilizing a suitable machine learning technique, the offer-determination computer 260 may alter (e.g., optimize) the offer-determination protocol based upon, for example, the acceptance or failure to accept the customized offer. Additionally, in some embodiments, the offer-determination computer 260 may alter (e.g., optimize) the offer-determination protocol further based upon various additional inputs, such as the duration of time that passed prior to acceptance of the customized offer or the like. Also, in some embodiments, the offer-determination computer 260 may send further electronic messages (e.g., an electronic survey) to a potential customer to determine further information with regard to that potential customer's acceptance or rejection of a customized offer and may use any response to those surveys to further update the offer-determination protocol.

In various embodiments, the offer-determination computer 260 may alter the offer-determination protocol with respect to the attributes of the potential customer that are relied upon in the determination of a customized offer; the weight applied to a particular attribute of the potential customer that are relied upon in the determination of a customized offer; the determination of one or more of the offer attributes; the presentation of the customized offer; the date or time at which the customized offer is presented; the appearance of the customized offer, as presented; the method or protocol by the electronic message conveying the customized offer is sent; the timing or frequency of follow-up electronic messages; or combinations thereof.

The methods and systems disclosed herein present various benefits and advantages. For example, the methods and systems disclosed herein may more closely achieve the goals of the offeror (e.g., improved profitability; decreased cost; improved customer retention, etc.) by targeting potential customers with offers specifically tailored to that potential customer in such a way as to achieve those goals. These methods and system recognize that all potential customers are not equal, that is, that various customers may prove more valuable to the offeror that others. In various embodiments, the methods and systems disclosed herein may yield improved customers that are relatively more valuable to the offeror, for example, customers, that are less likely to default on payments or cause damage to property of the offeror (e.g., in the context of an apartment lease or auto lease). Additionally or alternatively, in some embodiments, the methods and systems disclosed herein may yield improved customer retention, for example, by customizing the offer presented to the potential customer so as to maximize appeal to the potential customer. Additionally or alternatively, in in some embodiments, the methods and systems disclosed herein may decrease the costs associated with customer retention and/or customer turnover, again by customizing the offer presented to the potential customer so as to maximize appeal to the potential customer. As such, the methods and systems disclosed herein may yield increased profitability and/or decreased losses and expenditures by businesses offering products or services. In some embodiments, the benefits and advantages may be particularly applicable to businesses the offer products or services on a recurring basis, for example, where a potential customer must renew a term of service or other product agreement. Examples of such offerings include, but are not limited to, real-estate (e.g., apartment) leases, auto lease, and mobile phone services agreements.

Also, in some embodiments the methods and disclosed herein are particularly advantageous in that these methods and systems particularly improve the functioning of a computer system, for example, the disclosed offer-determination computer 260. For example, utilizing the offer-determination protocol to filter the multitude of available attributes to only those most-pertinent to the determination of the customized offer increases the efficiency and operation of the disclosed offer-determination computer 260. Moreover, the application of various machine-learning techniques to the improvement of the offer-determination protocol yields further improvements, both in terms of efficiency and processing speed, to the offer-determination computer 260. Also, in some embodiments the methods and disclosed herein are particularly advantageous in that these methods and systems particularly overcome problems specifically arising in the realm of computer systems. For example, utilizing the offer-determination protocol to filter the multitude of available attributes to only those most-pertinent to the determination of the customized offer overcomes problems specifically-related to the operation of the offer-determination computer 260. Moreover, the application of various machine-learning techniques to the improvement of the offer-determination protocol also problems specifically-related to the operation of the offer-determination computer 260. Further, in some embodiments the methods and disclosed herein are particularly advantageous in that these methods and systems particularly overcome problems associated with communications between various computing components or systems, for example, via communications networks such as a broadband network, an optical network, a Wi-Fi network, a Bluetooth network, a near-field communication (NFC) network, a cellular network, a satellite network, a cloud network, a card processing network, a banking network, a local area network, the World Wide Web for Internet, a non-cellular mobile phone network, a land-line network, a Public Switched Telephone Network (PSTN), a dedicated communication line, some other networks for transferring electronic information, or combinations thereof.

As an example of the applicability of the methods and systems previously disclosed here, are more particularly disclosed with respect to an apartment leasing context. In the apartment leasing context, the potential apartment leasee may be a current leasee of a particular property who is nearing the end of their existing rental term; alternatively, the potential apartment leasee may be a person who has demonstrated interest in a property. In some embodiments, in the performance of a method for developing and presenting customized offers to a potential apartment leasee, the offer-determination computer 260 may access the customer information database 240 (alternatively, multiple customer information databases 240) to acquire a plurality of attributes associated with each of plurality of potential leasees. Where the potential customer is a preexisting customer, the customer information database 240 may be a database comprising information about current residents. For example, the customer information database 240 may include information about the resident including the resident's transaction history (e.g., missed or late payments), income, family (e.g., family size), and history of past dealings with the resident (for example, if the resident has been problematic, such as by causing property damage or by lodging an abnormally high number of requests or complaints).

In some embodiments, the offer-determination computer 260 may utilize the plurality of attributes associated with each of the plurality of potential leasees to determine which of the plurality of potential leasees should receive a customized offer. The offer-determination computer 260 may implement the offer-determination protocol to determine those potential leasees who it is most-desirable to present with an offer. For example, in the apartment leasing context, the offer-determination computer 260 may filter out those potential leasees who are deemed problematic (such as by causing property damage or by lodging an abnormally high number of requests or complaints) or who have a history of failing to make regular payments.

In some embodiments, the offer-determination computer 260 may utilize the plurality of attributes associated with a first potential customer and a plurality of attributes associated with the apartment to be offered for lease to determine the customized offer for the first potential leasee. For example, the offer-determination computer 260 may determine one or more of the suitability of the particular apartment to be leased to the first potential leasee (such whether the particular apartment would be an appropriate size for the first potential leasee, based upon family size or whether the particular apartment allows pets, if the owner has one or more pets); the affordability of the particular apartment (such as by comparing the first potential leasee's income and a prospective monthly payment; the desirability of a transaction with the first potential leasee (such as by considering the first potential leasee's payment history, credit score, or whether or not the first potential has demonstrated a tendency to be problematic); or what incentives might best entice the first potential leasee to accept the offer (such as by consideration of hobbies and interests or any other attributes). These, or any number of other attributes associated with the first potential leasee and the particular apartment are utilized by the offer-determination protocol to develop a customized offer specific to the first potential leasee. Thus, while conventional techniques associated with targeted marketing may broadly filter potential customers to those customers who meet certain criteria, the offer-determination protocol disclosed herein, instead, evaluates various criteria in its entirety to develop an offer that is comparably much more likely to be accepted by the particular customer. Additionally, in the context of apartment leasing—where there are a limited number of apartments that can be leased at any one time—the offer-determination protocol can determine which, from among a plurality of potential leasees, should receive an offer in order to meet offeror-designated criteria (e.g., maximum profitability). For example, the offer-determination computer might determine customized offers for two potential leasees with respect to the same apartment but might determine that a second potential leasee is likely to accept an offer at a higher price (or with a lesser incentive). In this way, the offer-determination computer 260 can help the offeror to maximize its profitability. In the same way, the offer-determination computer 260 can likewise help to achieve various other offeror goals.

In some embodiments, upon determining the customized offer to be presented, the offer-determination computer 260 may present the customized offer to the to the first potential leasee via a suitable electronic message. For example, in the case where the first potential leasee is the prior leasee, the offer-determination computer 260 may format the offer a text message indicating an offer to renew the apartment lease is available to be viewed via a website to which the first potential leasee is directed and may send the text message to the first potential leasee.

Upon receiving the text message, via the user device 220, the first potential leasee may click the link to view the customized offer and be directed to a landing page setting forth the specific offer attributes, such as the monthly payment being offered, an incentive available for accepting the customized offer (e.g., renewing the lease), and an “Accept” or “Renew” button, allowing the first potential leasee to accept the customized offer and review the lease. Additionally, the landing page may present other information helpful to the potential leasee in determining whether or not to renew, such as the pricing or availability of comparable, nearby apartments or the costs associated with moving. In this way, the offer-determination protocol not only benefits the offeror, but the potential leasee as well, for example, while simplifying both the decision to renew an apartment lease and the renewal process.

In some embodiments, the offer-determination computer 260 may monitor the response of the first potential leasee to receipt of the customized offer, for example, by determining whether or not the first potential leasee has renewed their apartment lease (e.g., clicked the acceptance link). If the first potential leasee fails to renew the lease, the offer-determination computer 260 send one or more follow-up messages, as previously discussed. In some embodiments, upon a determination that the first potential leasee has accepted the customized offer, the offer-determination computer 260 may, responsive to the acceptance, generate and send to the first potential customer one or more additional forms, documents, or the like for presentation to the first potential customer, for example, a lease agreement or renewal agreement.

Also, in some embodiments, the offer-determination computer 260 may update the offer-determination protocol based upon the response of the potential customer. Utilizing one or more suitable machine-learning techniques, the offer-determination protocol computer 260 may update the offer-determination protocol such that, when implemented, the offer-determination protocol will determine customized offers that more nearly achieve the desired criteria when determining future customized offers for apartment leases.

As another example of the applicability of the methods and systems previously disclosed here, are more particularly disclosed with respect to an automobile leasing context. In the automobile leasing context, the potential automobile leasee may be a prior leasee of a vehicle who is nearing the end of their existing automobile lease; alternatively, the potential automobile leasee may be a person who has demonstrated interest in an automobile lease property. In some embodiments, in the performance of a method for developing and presenting customized offers to a potential automobile leasee, the offer-determination computer 260 may access the customer information database 240 (alternatively, multiple customer information databases 240) to acquire a plurality of attributes associated with each of plurality of potential leasees. Where the potential customer is a preexisting customer, the customer information database 240 may be a database comprising information about current customers. For example, the customer information database 240 may include information about the resident including the resident's transaction history (e.g., missed or late payments), income, family (e.g., family size), vehicle preferences, vehicle care history, criminal records, or driving history (e.g., number of moving violations, etc.).

In some embodiments, the offer-determination computer 260 may utilize the plurality of attributes associated with each of the plurality of potential leasees to determine which of the plurality of potential leasees should receive a customized offer. The offer-determination computer 260 may implement the offer-determination protocol to determine those potential leasees who it is most-desirable to present with an offer. For example, in the automobile leasing context, the offer-determination computer 260 may filter out those potential leasees who are deemed problematic (such as by causing damage to previously-leased vehicles) or who have a history of failing to make regular payments.

In some embodiments, the offer-determination computer 260 may utilize the plurality of attributes associated with a first potential customer and a plurality of attributes associated with various potential vehicles to be offered for lease to determine the customized offer for the first potential leasee. For example, the offer-determination computer 260 may determine one or more of the suitability of the particular vehicle to be leased to the first potential leasee (such whether the particular vehicle would be an appropriate size for the first potential leasee, based upon family size; the average annual miles driven by the first potential leasee; the use for the vehicle to be leased (e.g., commuting, work, or pleasure); the mileage or maintenance requirements of the vehicle; the preferences indicated for the first potential leasee, such as color, mark, model, or style); the affordability of the particular vehicle (such as by comparing the first potential leasee's income and a prospective monthly payment; or what incentives might best entice the first potential leasee to accept the offer (such as by consideration of hobbies and interests or any other attributes or any special offer, for example, based upon the attributes of the potential leasee). These, or any number of other attributes associated with the first potential leasee and the particular vehicle are utilized by the offer-determination protocol to develop a customized offer specific to the first potential leasee. Particularly, the offer-determination computer 260 may, based upon these attributes and others (e.g., available inventory of vehicles) determine a customized offer, with respect to a particular vehicle specific to the first potential leasee.

As similarly noted with respect to the apartment leasing context, while conventional techniques associated with targeted marketing may broadly filter potential customers to those customers who meet certain criteria, the offer-determination protocol disclosed herein, instead, evaluates various criteria in its entirety to develop an offer that is comparably much more likely to be accepted by the particular customer. In the context of automobile leasing—where the number of vehicle available for lease is not particular limited (as with apartments)—the offer-determination protocol can determine an offer for all potential leases that will help to ensure that nearly all available vehicles are being leased. For example, the offer-determination computer might determine customized offers for two potential leasees with respect to the same similar vehicles but might determine that a second potential leasee is likely to accept an offer at a higher price (or with a lesser incentive). In this way, the offer-determination computer 260 can help the offeror to maximize its profitability, such as by offering the first and second vehicles at prices that are likely to be accepted and, thus, helping to ensure that both vehicles are actually leased. In the same way, the offer-determination computer 260 can likewise help to achieve various other offeror goals.

In some embodiments, upon determining the customized offer to be presented, the offer-determination computer 260 may present the customized offer to the to the first potential leasee via a suitable electronic message. For example, in the case where the first potential leasee is the prior leasee, the offer-determination computer 260 may format the offer a text message indicating an offer for a new automobile lease is available to be viewed via a website to which the first potential leasee is directed and may send the text message to the first potential leasee.

Upon receiving the text message, via the user device 220, the first potential leasee may click the link to view the customized offer and be directed to a landing page setting forth the specific offer attributes, such as the monthly payment being offered, an incentive available for accepting the customized offer (e.g., renewing the lease), and an “Accept” or “Renew” button, allowing the first potential leasee to accept the customized offer and review the lease. Additionally, the landing page may present other information helpful to the potential leasee in determining whether or not to renew, such as the pricing or availability of comparable, nearby vehicles, other vehicles in inventory, vehicle review and ratings (e.g., safety ratings or mileage). In this way, the offer-determination protocol not only benefits the offeror, but the potential leasee as well, for example, while simplifying both the decision to seek a new automobile lease.

In some embodiments, the offer-determination computer 260 may monitor the response of the first potential leasee to receipt of the customized offer, for example, by determining whether or not the first potential leasee has renewed their automobile lease (e.g., clicked the acceptance link or visited the car-dealership presenting the offer). In some embodiments, upon a determination that the first potential leasee has accepted the customized offer, the offer-determination computer 260 may, responsive to the acceptance, generate and send to the first potential customer one or more additional forms, documents, or the like for presentation to the first potential customer, for example, a lease agreement or vehicle financing application.

Also, in some embodiments, the offer-determination computer 260 may update the offer-determination protocol based upon the response of the potential customer. Utilizing one or more suitable machine-learning techniques, the offer-determination protocol computer 260 may update the offer-determination protocol such that, when implemented, the offer-determination protocol will determine customized offers that more nearly achieve the desired criteria when determining future customized offers for automobile leases.

The ordering of steps in the various processes, data flows, and flowcharts presented are for illustration purposes and do not necessarily reflect the order that various steps must be performed. The steps may be rearranged in different orders in different embodiments to reflect the needs, desires and preferences of the entity implementing the systems. Furthermore, many steps may be performed simultaneously with other steps in some embodiments.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed.

It will be apparent to those skilled in the art that modifications may be made without departing from the spirit and scope of the disclosure. The embodiments described are representative only and are not intended to be limiting. Many variations, combinations, and modifications of the applications disclosed herein are possible and are within the scope of the disclosure. Accordingly, the scope of protection is not limited by the description set out above, but is defined by the claims which follow, that scope including all equivalents of the subject matter of the claims.

What is claimed is:

1. A computer-implemented method comprising:
acquiring a plurality of attributes associated with each of a plurality of potential customers;
determining, based upon the plurality of attributes associated with each of the plurality of potential customers, potential customers to receive customized offers;
determining, via an offer-determination protocol, a customized offer for a first potential customer based upon at least some of the plurality of attributes associated with the first potential customer;
presenting the customized offer to the first potential customer;
monitoring a response of the first potential customer to receiving the customized offer; and
updating the offer-determination protocol based upon the response of the potential customer.

2. The computer-implemented method of claim 1, wherein the plurality of customer attributes associated with a potential customer includes a name of the potential customer, an income of the potential customer, a credit score of the potential customer, an occupation of the potential customer, a hobby or interest of the potential customer, an address of the potential customer, an email of the potential customer, a mobile phone number of the potential customer, a purchasing history of the potential customer, a payment history of the potential customer, a social network identity of the potential customer, a marital status of the potential customer, whether the potential customer has children, whether the potential customer has pets, a criminal history of the potential customer, a number of complaints lodged by the potential customer, or combinations thereof.

3. The computer-implemented method of claim 1, wherein determining, via the offer-determination protocol, the customized offer for the first potential customer is further based upon at least some of a plurality of attributes associated with the a good or service to which the customized offer is related.

4. The computer-implemented method of claim 1, wherein presenting the customized offer comprises sending an electronic message.

5. The computer-implemented method of claim 1, wherein the electronic message comprises an email or a text message.

6. The computer-implemented method of claim 5, wherein the electronic message includes a link to a landing page that sets forth at least some of a plurality of offer attributes.

7. The computer-implemented method of claim 6, wherein the offer attributes include a product or service to which the offer is related, a price of the product or service, a financing term associated with the customized offer, a discount applicable to the customized offer; an incentive conditioned on acceptance of the customized offer, or combinations thereof.

8. The computer-implemented method of claim 6, wherein the landing page includes an “accept” button, and wherein monitoring the response of the first potential customer to receiving the customized offer comprises determining whether the accept button has been clicked.

9. The computer-implemented method of claim 1, wherein updating the offer-determination protocol based upon the response of the potential customer comprises a machine-learning methodology.

10. The computer-implemented method of claim 9, wherein the machine-learning methodology comprises rule-based learning, association rule learning, artificial neural networks, deep learning, support vector machine learning, cluster analysis, representation learning, learning classification systems, or combinations thereof.

11. The computer-implemented method of claim 1, wherein the customized offer is for an apartment lease.

12. The computer-implement method of claim 1, wherein the customized offer is for an automobile lease.

13. A system for developing and presenting customized offers to a potential customer, the system comprising:
a customer information database; and
an offer-determination computer in signal communication with the customer information database and a user device, the offer-determination computer configured to:
acquire from the customer information database a plurality of attributes associated with each of a plurality of potential customers;
determine, based upon the plurality of attributes associated with each of the plurality of potential customers, potential customers to receive customized offers;
determine, via an offer-determination protocol, a customized offer for a first potential customer based upon at least some of the plurality of attributes associated with the first potential customer;
present, via the user device, the customized offer to the first potential customer;
monitor a response of the first potential customer to receiving the customized offer; and
update the offer-determination protocol based upon the response of the potential customer.

14. The system of claim 13, wherein the plurality of customer attributes associated with a potential customer includes a name of the potential customer, an income of the potential customer, a credit score of the potential customer, an occupation of the potential customer, a hobby or interest of the potential customer, an address of the potential customer, an email of the potential customer, a mobile phone number of the potential customer, a purchasing history of the potential customer, a payment history of the potential customer, a social network identity of the potential customer, a marital status of the potential customer, whether the potential customer has children, whether the potential customer has pets, a criminal history of the potential customer, a number of complaints lodged by the potential customer, or combinations thereof.

15. The system of claim 13, wherein the offer-determination computer is further configured to determine, via the offer-determination protocol, the customized offer for the first potential customer based upon at least some of a plurality of attributes associated with the a good or service to which the customized offer is related.

16. The system of claim 13, wherein the offer-determination computer is configured to present the customized offer by sending an electronic message.

17. The system of claim 13, wherein the electronic message comprises an email or a text message.

18. The system of claim 17, wherein the electronic message includes a link to a landing page that sets forth at least some of a plurality of offer attributes.

19. The system of claim 18, wherein the offer attributes include a product or service to which the offer is related, a price of the product or service, a financing term associated with the customized offer, a discount applicable to the customized offer; an incentive conditioned on acceptance of the customized offer, or combinations thereof.

20. The system of claim 18, wherein the landing page includes an “accept” button, and wherein the offer-determination computer is configured to monitor the response of the first potential customer to receiving the customized offer comprises by determining whether the accept button has been clicked.

21. The system of claim 13, wherein the offer-determination computer is configured to update the offer-determination protocol based upon the response of the potential customer by a machine-learning methodology.

22. The system of claim 21, wherein the machine-learning methodology comprises rule-based learning, association rule learning, artificial neural networks, deep learning, support vector machine learning, cluster analysis, representation learning, learning classification systems, or combinations thereof.

23. The system of claim 13, wherein the customized offer is for an apartment lease.

24. The system of claim 13, wherein the customized offer is for an automobile lease.
